(19) United States
(12) Patent Application Publication
(10) Pub. No.: US 2010/0007755 A1
(43) Pub. Date: Jan. 14, 2010

(54) SYSTEM AND METHOD FOR EXECUTING FUNCTIONS ACCORDING TO CAPTURED IMAGES

(75) Inventor: CHIEN-CHEN LEE, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Chi Mei Communication Systems, Inc., Tu-Cheng City (TW)

(21) Appl. No.: 12/414,613

(22) Filed: Mar. 30, 2009

(30) Foreign Application Priority Data
Jul. 8, 2008 (CN) 200810302662.9

(51) Int. Cl. H04N 5/228; H04M 1/00; G06K 9/00; G06K 9/68

(52) U.S. Cl. 348/222.1; 455/556.1; 382/181; 382/218

(57) ABSTRACT

A system and method for executing functions according to a captured image on an electronic device are provided. The method includes defining at least one function images; capturing the captured image after the capture signal is received; recognizing if the captured image is equivalent to the at least one function images; and executing a corresponding function of the at least one function images if the captured image is equivalent to the at least one function image.

### BACKGROUND

1. Field of the Invention

Embodiments of the present disclosure relate to functions activation, and more particularly to a system and a method for executing functions according to captured images on a portable electronic device.

2. Description of Related Art

Currently, as the rapid development of such technology, mobile phones provide more and more functions. These functions provide many conveniences for a user.

However, these conveniences also cause annoyance and danger for the users of mobile phones. For example, drivers may operate mobile phones when using Global Position System services, playing MP3 files, and so on, while the drivers are operating their vehicles. Danger of operating mobile phones while operating the vehicles and the like is well known.

Accordingly, a system and a method for reducing the aforementioned problem is needed.

### BRIEF DESCRIPTION OF THE DRAWINGS

FIG. 1 is a block diagram of an embodiment of a system for executing functions by captured images;

FIG. 2 is a flowchart of an embodiment of a method of defining corresponding functions for at least one function images; and

FIG. 3 is a flowchart of an embodiment of a method for executing functions by the captured images.

### DETAILED DESCRIPTION OF CERTAIN INVENTIVE EMBODIMENTS

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

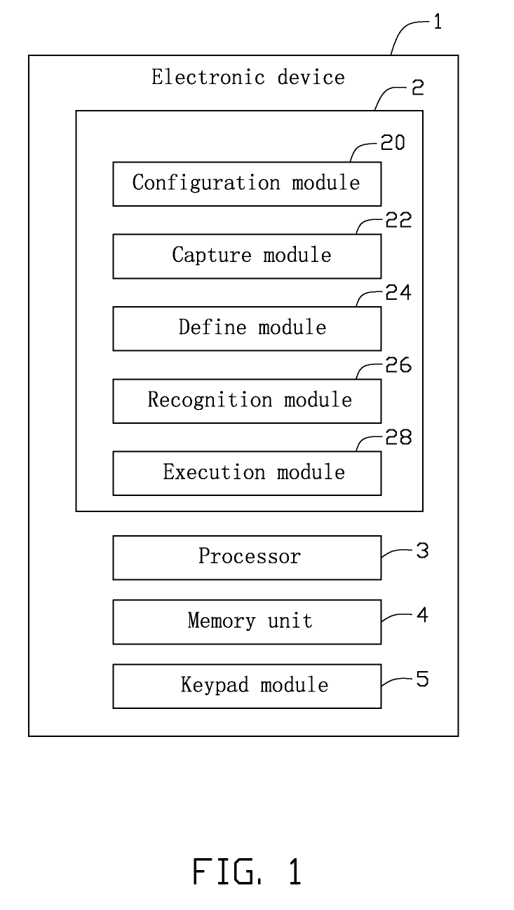

FIG. 1 is a block diagram of an embodiment of a system 2 for executing functions by captured images (hereinafter “the system 2”). An electronic device 1, such as a mobile phone, includes the system 2, a processor 3 for executing the system 2, a memory unit 4, and a keypad module 5. Portable and non-portable electronic devices other than the mobile phone shown here, such as notebook computers and personal digital assistants (PDAs), for example, may equally utilize the system 2, without departing from the spirit of the disclosure.

The system 2 is configured for capturing one or more images and defining corresponding functions for at least one of the images if the at least one of the images corresponds to a function image. A function image is defined as an image defined with a specific corresponding function. The corresponding function is activated after determining that a captured image is equivalent to one of the function images. For example, an image containing a specific hand gesture, such as “V-sign,” may be defined as a function image (hereinafter referred to as “V-sign function image”). The function of making a phone call to a specific friend may be associated with the V-sign function image. The system 2 makes a phone call to the specific friend upon determining that the captured image is equivalent to the V-sign function image. In this way, users are capable of executing a plurality of functions using simple gestures without executing too many menu selections.

The processor 3 executes program instructions in order to carry out the functions of the present disclosure. Typically, processor 3 is a microprocessor, such as an INTEL PENTIUM.RTM. processor, but may also be a minicomputer or mainframe computer processor. In alternative embodiments, the processor 3 may be single-processor computer systems, multi-processor computer systems, or a mix thereof.

The memory unit 4 stores program instructions that are executed by, and data that are used and processed by, the processor 3 to perform the functions of the present disclosure. The memory unit 4 may include electronic memory devices, such as random-access memory (RAM), read-only memory (ROM), programmable read-only memory (PROM), electrically erasable programmable read-only memory (EEPROM), flash memory, etc.

In one embodiment, the system 2 includes a configuration module 20, a capture module 22, a define module 24, a recognition module 26 and an execution module 28, in addition to other hardware and software components of the system 2.

The configuration module 20 is configured for setting activation keys on the electronic device 1. The activation keys includes at least one define key and at least one capture key. The define key is for instructing the capture module 22 to enter a define mode. In the define mode, the capture module 22 shoots the image and saves the image as the function image. The capture key is for instructing the capture module 22 to enter a capture mode. In the capture mode, the capture module 22 captures the image and saves the image as the captured image. It may be understood that the word “shoots” and the word “capture” define the action of taking a digital picture of an object, such as an animal or a flower, for example. For the purpose of explanation and for clarification, the word “shoots” is used to refer to taking a picture in the define mode, and the word “capture” is used to refer to taking a picture in the capture mode.

The define key and the capture key respectively generate a define signal and a capture signal upon being pressed to be transmitted to the capture module 22. It is to be noted that the activation keys may be any key arranged on the keypad module 5 of the electronic device 1, such as “#” or “*.”

The capture module 22 is configured for entering the define mode after the define signal is received. After entering the define mode, the capture module 22 shoots the function images and saves the function images in the memory unit 4.

Upon detecting a saved function image, the define module 24 is configured for defining corresponding functions for a plurality of function images. For the above example, the define module 24 associates the function of making the phone call to the specific friend with the V-sign function image. In other example, the corresponding function may be to play MP3 files or displaying a specific menu of the electronic device 1.

The capture module 22 is configured for entering the capture mode after the capture signal is received or after a specific time period has elapsed. The time period may be defined by the configuration module 20. For example, the time period may be defined as 5 seconds and the capture module 22 enters the capture mode after the capture signal is received for 5 seconds. After entering the capture mode, the capture module 22 captures the captured image and saves the captured image to the memory unit 4.

Upon detecting a saved captured image, the recognition module 26 is configured for recognizing if the captured image is equivalent to one of the function images. In one embodiment, the recognition module 26 is configured for obtaining a plurality of patterns of the function images so as to recognize the captured images. The patterns of the function images are stored in the memory unit 4.

After reading the captured image from the memory unit 4, the recognition module 26 is configured for obtaining the patterns of the captured images. The recognition module 26 is further configured for comparing the patterns of the captured images with the patterns of the plurality of the function images to determine if the captured image is equivalent to one of the function images. In one embodiment, an execution signal is generated and transmitted to the execution module 28 after determining that the captured image is equivalent to one of the function images.

The execution module 28 is configured for executing the corresponding function of the function image after the execution signal is received.

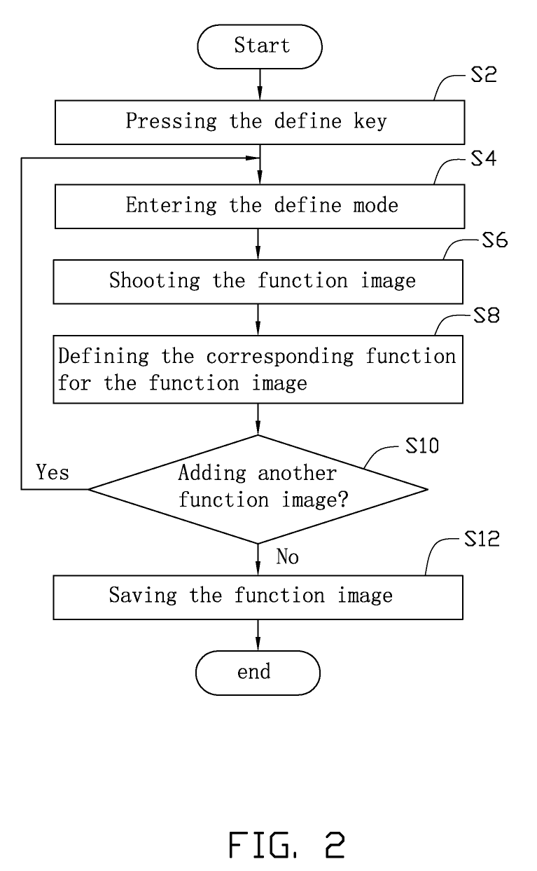

FIG. 2 is a flowchart of an embodiment of a method for defining corresponding functions for at least one function image. The method of FIG. 2 may be used for shooting a function image and defining a corresponding function for the function image. Depending on the embodiment, additional blocks may be added or deleted and the blocks may be executed in order other than that described.

In block S2, the define key on the keypad module 5 is pressed so as to instruct the capture module 22 to enter the define mode. The define key generates a define signal upon being pressed. It is to be noted that the define key may be any key arranged on the keypad module 5 of the electronic device 1, such as “#” or

In block S4, the capture module 22 receives the define signal and enters the define mode. It is to be noted that in the define mode, the capture module 22 shoots an image and saves the image as a function image.

In block S6, the capture module 22 shoots a function image. The function image is then saved in the memory unit 4. For example, a hand gesture including three fingers is shot and saved in the memory unit 4. In block S8, the define module 24 defines a corresponding function for the function image. For the above-example, a function of playing MP3 files is associated with the 3-fingers function image.

In block S10, the define module 24 determines whether another function image is to be captured. If another function image is to be added, the process goes back to block S6 to repeat the above blocks. If there are no other images to be added to the function image, in block S12, the function image is stored in the memory unit 4. Thus, a plurality of images may be added to be function images and the corresponding functions may be respectively associated with the plurality of function images.

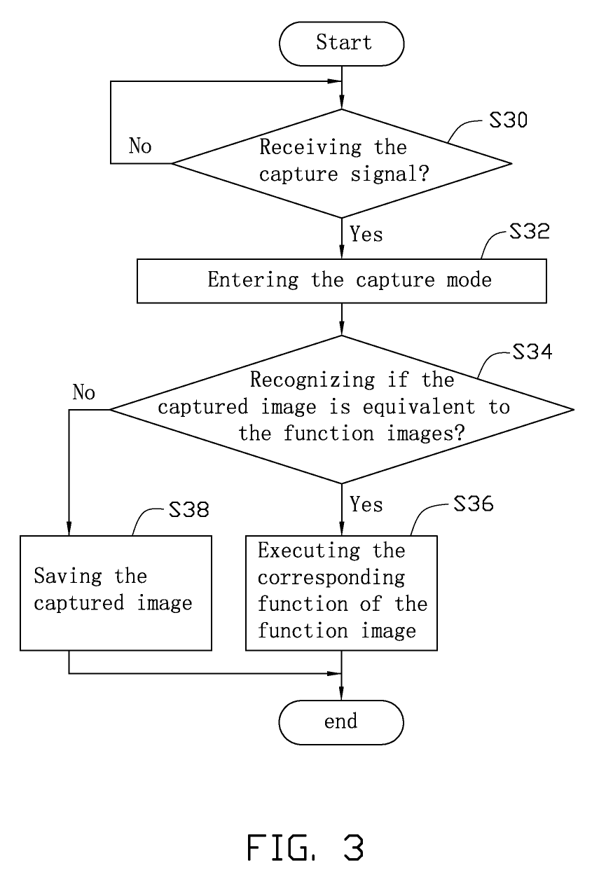

FIG. 3 is a flowchart of an embodiment of a method for executing functions by the captured images. The method of FIG. 3 may used for executing functions by comparing the captured image with the function images. Depending on the embodiment, additional blocks may be added or deleted and the blocks may be executed in order other than that described.

In block S30, the capture module 22 determines if the capture signal is received. As mentioned above, the capture signal is generated and transmitted to the capture module 22 upon the capture key is being pressed. It is to be noted that the capture key may be any key arranged on the keypad module 5 of the electronic device 1, such as “#or ” “*.”

If the capture signal is received, in block S32, the capture module 22 enters the capture mode and captures the captured image. In the embodiment, the capture module 22 enters the capture mode upon receiving the capture signal. In alternative embodiments, the capture module 22 enters the capture mode after a time period, such as 3 seconds, has elapsed. The time period may be defined by the configuration module 20.

If the capture signal is received, the process goes back to block S30.

In block S34, the recognition module 26 recognizes if the captured image is equivalent to one of the function images. In order to recognize if the captured image is equivalent to one of the function images, the recognition module 26 respectively obtains a plurality of patterns for the function images and the captured images. The patterns of the captured images are then compared with the patterns of the function images so as to determine the equivalence.

If the captured image is equivalent to one of the function image, in block S36, the execution module 28 executes the corresponding function of the function image. Otherwise, in block S38, the capture module 22 saves the captured image to the memory unit 4.

It is important to note that while the disclosure has been described in the context of a fully functioning data processing system, those of ordinary skill in the art will appreciate that the processes of the disclosure are capable of being distributed in the form of a computer readable medium of instructions and a variety of forms and that the disclosure applies equally regardless of the particular type of signal bearing media actually used to carry out the distribution. Examples of computer readable media include recordable-type media such as floppy disc, a hard disk drive, random access memory (RAM), and compact disc-read only memory (CD-ROM), as well as transmission-type media, such as digital and analog communications links.

It should be emphasized that the described inventive embodiments are merely possible examples of implementations, and set forth for a clear understanding of the principles of the present disclosure. Many variations and modifications may be made to the above-described inventive embodiments without departing substantially from the spirit and principles of the present disclosure. All such modifications and variations are intended to be included herein within the scope of this disclosure and the above-described inventive embodiments, and the present disclosure is protected by the following claims.

What is claimed is:

1. An electronic device for executing functions according to a captured image, the electronic device comprising a camera system, the electronic device further comprising:
a configuration module configured for setting activation keys on the electronic device, the activation keys comprising at least one define key and at least one capture key, the define key and the capture key respectively generating a define signal and a capture signal after being pressed;
a capture module configured for entering a define mode to shoot function images after the define signal is received, and for entering a capture mode to capture the captured image after the capture signal is received;
a define module configured for defining corresponding functions for the function images;
a recognition module configured for recognizing if the captured image is equivalent to one of the function images; and
an execution module configured for executing the corresponding functions for the function images if the captured image is equivalent to one of the function images.

2. The system as claimed in claim 1, wherein the activation keys are arranged on a keypad module of the electronic device.

3. The system as claimed in claim 1, wherein the capture module enters the capture mode after the capture signal is received after a defined time period.

4. The system as claimed in claim 1, wherein the recognition module is further configured for obtaining a plurality of patterns of the function images.

5. The system as claimed in claim 4, wherein the recognition module is further configured for obtaining patterns of the captured image.

6. The system as claimed in claim 5, wherein the recognition module is further configured for comparing the patterns of the captured image with a plurality of patterns of the function images to determine if the captured image is equivalent to one of the function images.

7. A computer-implemented method for executing functions according to a captured image on an electronic device, the method comprising:
setting a capture key on the electronic device, the capture key generating a capture signal when being pressed;
defining at least one function images;
capturing the captured image after the capture signal is received;
recognizing if the captured image is equivalent to the at least one function images; and
executing a corresponding function of the at least one function images if the captured image is equivalent to the at least one function images.

8. The method as claimed in claim 7, wherein the setting step further comprising setting a define key on the electronic device, the define key generating a define signal after being pressed.

9. The method as claimed in claim 8, wherein the defining step is executed after the define signal is generated, and the defining step further comprising:
shooting the at least one function images; and
defining corresponding functions for a plurality of function images.

10. The method as claimed in claim 9, further comprising:
defining a time period; and
capturing the captured image after the capture signal is received for the time period.

11. The method as claimed in claim 9, further comprising:
obtaining a plurality of patterns of the at least one function images.

12. The method as claimed in claim 11, further comprising:
obtaining the patterns of the captured images; and
comparing the patterns of the captured images with the patterns of the at least one function images to determine if the captured image is equivalent to the at least one function images.

13. A computer-readable medium for executing functions according to a captured image on an electronic device, the computer-readable medium having stored thereon instructions that, when executed by the electronic device, cause the electronic device to:
set a capture key on the electronic device, the capture key generating a capture signal when being pressed;
define at least one function images;
capture the captured image after the capture signal is received;
recognize if the captured image is equivalent to the at least one function images; and
execute a corresponding function of the at least one function images if the captured image is equivalent to the at least one function images.

14. The computer-readable medium as claimed in claim 13, wherein the setting step further comprising setting a define key on the electronic device, the define key generating a define signal after being pressed.

15. The computer-readable medium as claimed in claim 14, wherein the defining step is executed after the define signal is generated, and the defining step further comprising:
shoot the at least one function images; and
define corresponding functions for a plurality of function images.

16. The computer-readable medium as claimed in claim 15, further comprising:
define a time period; and
capture the captured image after the capture signal is received for the time period.

17. The computer-readable medium as claimed in claim 15, further comprising:
obtain a plurality of patterns of the at least one function images.

18. The computer-readable medium as claimed in claim 17, further comprising:
obtain the patterns of the captured images; and
compare the patterns of the captured images with the patterns of the at least one function images to determine if the captured image is equivalent to the at least one function images.
